(19) United States
(12) Patent Application Publication
(10) Pub. No.: US 2021/0347578 A1
(43) Pub. Date: Nov. 11, 2021

(54) VIBRATORY APPARATUS, AND SYSTEM INCORPORATING SAME

(71) Applicant: General Kinematics Corporation, Crystal Lake, IL (US)

(72) Inventors: Oscar L. Mathis, JR., Cary, IL (US); Edward Steffes, JR., Woodstock, IL (US); Kerry Quinn, Palatine, IL (US)

(21) Appl. No.: 17/308,630

(22) Filed: May 5, 2021

Related U.S. Application Data
(60) Provisional application No. 63/021,072, filed on May 6, 2020.

(51) Int. Cl. B65G 27/32; F27B 3/18; B65G 27/04; B65G 27/20

(52) U.S. Cl. CPC B65G 27/32; F27B 3/18; B65G 27/04; B65G 27/20; B65G 27/34; B65G 2203/0258; B65G 2203/042; B65G 2811/095; B65G 2203/025

(57) ABSTRACT

A vibratory apparatus includes a deck and an exciter assembly coupled to the deck. The apparatus also includes a motion sensor, a weight sensor, and a control system coupled to the exciter assembly, the motion sensor, and the weight sensor. The control system is configured to pause the rate of travel of the material across the deck for a weighing interval, to receive the signal from the weight sensor representative of a material weight on the deck during the weighing interval, to resume the rate of travel for a transporting interval, to receive a signal from the motion sensor representative of a material flow rate during the transporting interval, to determine a material mass flow rate based on the signals from the weight sensor and the motion sensor and the weighing and transporting intervals, and to vary the operation of the exciter assembly according to the material mass flow rate.

### CROSS-REFERENCE TO RELATED APPLICATIONS

This patent claims the benefit of U.S. Provisional Patent App. No. 63/021,072, filed May 6, 2020, which is expressly incorporated herein by reference in its entirety.

### BACKGROUND

This patent is directed to a vibratory apparatus with mass flow control and a method of operating the same, and a system for feeding a furnace incorporating a vibratory apparatus with mass flow control and a method of operating the same.

### SUMMARY

According to one aspect of the present disclosure, a vibratory apparatus includes a deck having a longitudinal axis from a first end to a second, opposite end, and an exciter assembly including at least one eccentric mass and at least one motor coupled to the at least eccentric mass, the exciter assembly coupled to the deck and configured to move material along the deck. The apparatus also includes at least one motion sensor associated with the deck, the at least one motion sensor configured to generate a signal based on motion of material along the deck between the first end and the second end, at least one weight sensor coupled to the deck, the at least one weight sensor configured to generate a signal based on weight of material on the deck, and a control system coupled to the at least one motor, the at least one motion sensor, and the at least one weight sensor. The control system is configured to pause the rate of travel of the material across the deck for a weighing interval, to receive the signal from the at least one weight sensor representative of a material weight on the deck during the weighing interval, to resume the rate of travel of the material across the deck for a transporting interval, to receive a signal from the at least one motion sensor representative of a material flow rate during the transporting interval, to determine a material mass flow rate based on the signal from the at least one weight sensor, the signal from at least one motion sensor, the weighing interval and the transporting interval, and to vary the operation of the at least one motor according to the material mass flow rate.

According to another aspect of the present disclosure, a system to charge a furnace, the system including a conveyor system with a first inlet end and a second outlet end and including at least one conveyor, and a furnace disposed at the second end of the conveyor system. The at least one conveyor includes a conveyor including a deck having a longitudinal axis from a first end to a second, opposite end, and an exciter assembly including at least one eccentric mass and at least one motor coupled to the at least eccentric mass, the exciter assembly coupled to the deck and configured to move material along the deck. The conveyor also includes at least one motion sensor associated with the deck, the at least one motion sensor configured to generate a signal based on motion of material along the deck between the first end and the second end, at least one weight sensor coupled to the deck, the at least one weight sensor configured to generate a signal based on weight of material on the deck, and a control system coupled to the at least one motor, the at least one motion sensor, and the at least one weight sensor. The control system is configured to pause the rate of travel of the material across the deck for a weighing interval, to receive the signal from the at least one weight sensor representative of a material weight on the deck during the weighing interval, to resume the rate of travel of the material across the deck for a transporting interval, to receive a signal from the at least one motion sensor representative of a material flow rate during the transporting interval, to determine a material mass flow rate based on the signal from the at least one weight sensor, the signal from at least one motion sensor, the weighing interval and the transporting interval, and to vary the operation of the motor according to the material mass flow rate.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is side view an embodiment of a vibratory apparatus with mass flow control;

FIG. 2 is a side view of a part of an embodiment of a system incorporating the vibratory apparatus of FIG. 1;

FIG. 3 is a plan view of the conveyor system illustrated in FIG. 2; and

FIG. 4 is a schematic view of the extended system of FIG. 2 incorporating the vibratory apparatus of FIG. 1.

### DETAILED DESCRIPTION OF VARIOUS EMBODIMENTS

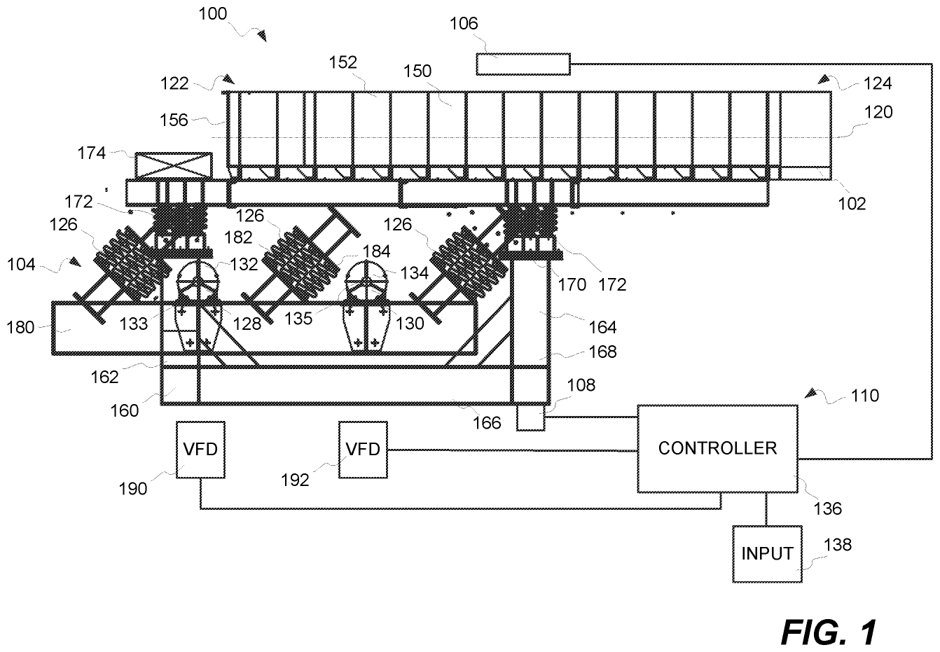

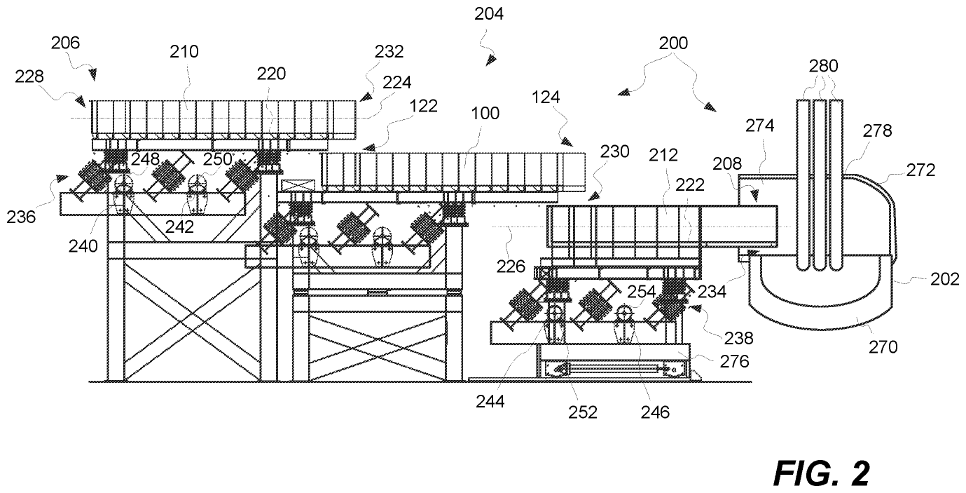

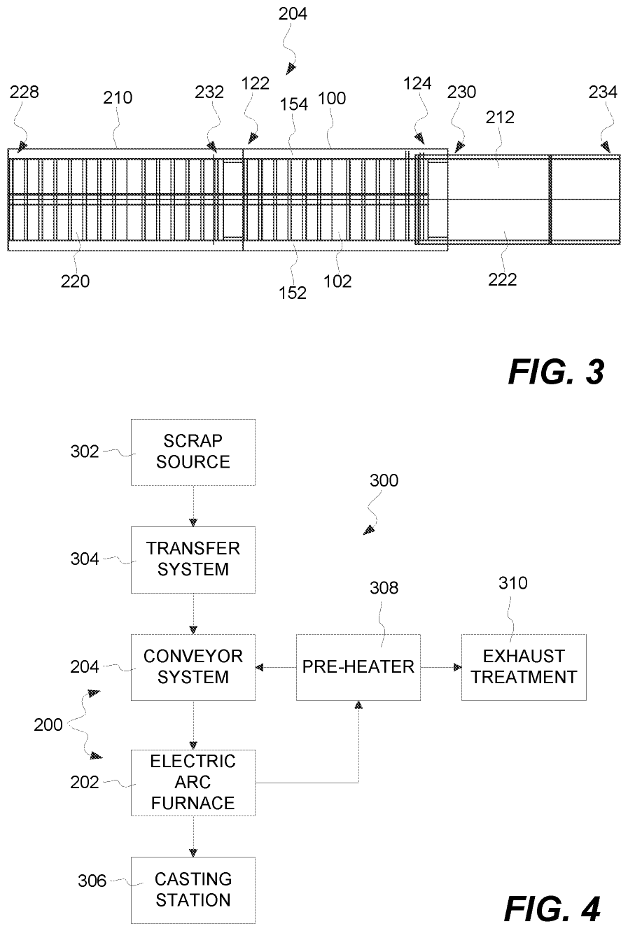

FIG. 1 illustrates an embodiment of a vibratory apparatus 100 with mass flow control. A system 200 incorporating the apparatus 100 of FIG. 1 is illustrated in part in FIGS. 2 and 3.

Turning first to FIG. 1, the vibratory apparatus 100 includes, in general terms, a deck 102, an exciter assembly 104, at least one motion sensor 106, at least one weight sensor 108, and a control system 110. The exciter assembly 104 (or exciter for short) is coupled physically to the deck 102. In addition, a portion of the exciter assembly 104, the at least one motion sensor 106, and the at least one weight sensor 108 are coupled electronically to the control system 110.

The deck 102 has a longitudinal axis 120 from a first end 122 to a second, opposite end 124. According to the illustrated embodiment, material is deposited onto the deck 102 at the first end 122, and travels along the deck 102 to the second end 124. To this end, the exciter assembly 104 is coupled to the deck 102, for example through a plurality of resilient members 126 (such as coil springs), and is configured to move material along the deck 102. The exciter assembly 104 includes at least one eccentric mass 128, 130 and at least one motor 132, 134 coupled to the at least eccentric mass 128, 130. As illustrated, the exciter assembly 104 includes two motors 132, 134, each with at least one eccentric mass 128, 130 attached thereto.

The at least one motion sensor 106 is associated with the deck 102, e.g., disposed over the deck 102, for example attached to a hood associated with the deck 102. The at least one motion sensor 106 is configured to generate a signal based on motion of material along the deck 102 between the first end 122 and the second end 124. The at least one motion sensor 106 may include one or more optical sensors, for example.

The at least one weight sensor 108 is also physically coupled to the deck 102. The at least one weight sensor 108 is configured to generate a signal based on weight of material on the deck 102. The at least one weight sensor 108 may be a load cell attached between the deck 102 and a surface.

The control system 110 may be electrically coupled to the at least one motor 132, 134 of the exciter assembly 104, the at least one motion sensor 106, and the at least one weight sensor 108. The control system 110 may be configured to pause the rate of travel of the material across the deck 102 for a weighing interval (for example, by reducing the rpm of the motor 132, 134 until there is no conveying motion on the deck 102), to receive the signal from the at least one weight sensor 108 representative of a material weight on the deck 102 during the weighing interval, to resume the rate of travel of the material across the deck 102 for a transporting interval, to receive a signal from the at least one motion sensor 106 representative of a material flow rate during the transporting interval, to determine a material mass flow rate based on the signal from the at least one weight sensor 108, the signal from at least one motion sensor 106, the weighing interval and the transporting interval, and to vary the operation of the at least one motor 132, 134 according to the material mass flow rate. The control system 110 may include a controller 136, such as a programmable logic controller, and associated equipment and/or software to permit communication with the motor 132, 134 and sensors 106, 108.

According to certain embodiments, the control system 110 is configured to determine a material weight per unit length based on the signal from the at least one weight sensor 108, to determine a material flow rate based on the signal from the at least one motion sensor 106, to determine an intermediate material flow rate based on the material weight per unit length and the material flow rate, and to determine the (average) material mass flow rate based on the intermediate material flow rate, a duration of the weighing interval, and a duration of the transporting interval. For example, the system 110 may be configured to determine the material mass flow rate based on the product of the intermediate material mass flow rate and a percentage of the transporting interval taken relative to a total interval, which is the sum of the weighing interval and the transporting interval.

In operation, the control system 110 may receive an input signal from an input device 138, which may be a user interface (e.g., switch or graphical user interface/touch screen) or another controller coupled to the control system 110. The input device or input 138 is configured to transmit a target mass flow rate to the control system 110. The control system 110 compares this target mass flow rate to the material mass flow rate determined based on the input from the weight and motion sensors 108, 106, and then changes the operation of the motor 132, 134 to achieve the target mass flow rate. For example, the control system 110 may utilize a feedback control loop.

Having thus described the general structure and operation of the vibratory apparatus 100, the apparatus 100 is described in greater detail with reference to FIGS. 1 and 3.

To begin, the deck 102 may be part of a trough 150, which trough 150 may include sidewalls 152, 154, only one of which is illustrated in FIG. 1, but both of which may be seen in FIG. 2. The trough 150 may also include an end wall 156 at the first end 122 of the deck 102, as the material enters at the first end 122 of the deck 102 and moves along the deck 102 to the second end 124. The trough 150 does not include an end wall at the second end 124 of the deck 102 as the intent is for the material to exit the trough 150 at that point.

The trough 150 is supported on the ground via a frame 160. The frame 160 has legs 162, 164 on each side of the frame 160 that extend upward from a body 166, between a first end 168 attached to the body 166 and a second end 170 attached to the trough 150. In particular, the second end 170 of the legs 162, 164 are attached to the trough 150 by one or more resilient members 172. As illustrated, each leg 162, 164 is attached to the trough 150 by a plurality of resilient members 172, each in the form of a coil spring and which may be referred to as isolation springs.

The trough 150 may be aligned with the frame 160, or may be extend more to one side or the other from the frame 160. As illustrated in FIG. 1, the trough 150 extends more to the right side of the frame 160, as viewed in FIG. 1. To this end, ballast 174 may be attached to the trough 150 for balance, for example via a beam that is attached to both the ballast 174 and the trough 150.

As mentioned previously, the exciter assembly 104 is coupled to the deck 102. As illustrated, the exciter assembly 104 is attached to the deck 102 through a plurality of resilient members 126, for example coil springs. As such, the exciter assembly 104 forms part of a two-mass system with the trough 150. It will be recognized, however, that according to other embodiments the exciter assembly 104 may be attached directly to the trough 102 to form a brute force system.

As illustrated, the exciter assembly 104 includes a platform 180. The platform 180 is coupled through the plurality of resilient members 126, or reaction springs, to the trough 150. As illustrated, the platform 180 is attached to the trough 150 by three separate pluralities of resilient members 126, each plurality of resilient members 126 attached at a first end 182 to the platform 180 and at a second end 184 to the trough 150. The embodiments are not limited to the number or arrangement of resilient members 126 illustrated, nor is the embodiment limited to an arrangement wherein the platform 180 is attached below or under the deck 102 (i.e., on the opposite side of the deck 102 from the surface on which material moves along the deck 102). The exciter assembly 104 may be disposed above the deck 102, but it may be advantageous to dispose the exciter assembly 104 below the deck 102 as illustrated to permit other structures to be attached to the trough 150 above the deck 102.

As also mentioned above, the exciter assembly 104 includes at least one eccentric mass 128, 130 and at least one motor 132, 134 coupled to the at least eccentric mass 128, 130. As illustrated, the at least one motor 132, 134 is attached to the platform 180, has a motor shaft 133, 135 transverse the longitudinal axis 120 of the deck 102, and the at least one eccentric mass 128, 130 is attached to the motor shaft 133, 135. According to other embodiments, the at least one eccentric mass 128, 130 may be attached to a shaft attached to the platform 180, and the motor 132, 134 may be disposed off the platform 180. According to such an embodiment, the motor shaft 133, 135 may be coupled to the shaft attached to the platform 180, and the motor 132, 134 thereby may be coupled to the at least one eccentric mass 128, 130 attached to the shaft.

The at least one motor 132, 134 may have a variable frequency drive 190, 192 associated therewith, which variable frequency drive 190, 192 may be considered part of the control system 110. The drive 190, 192 may be coupled to the at least one motor 132, 134 and to the controller 136 of the control system 110. The control system 110, more particularly the controller 136, may be configured (e.g., programmed) to control the variable frequency drive 190, 192 to change a revolutions per minute of the motor 132, 134 during the transporting interval, for example.

In the illustrated embodiment, the exciter assembly 104 includes two motors 132, 134, each with a motor shaft 133, 135 transverse the longitudinal axis 120 of the deck 102, and at least one eccentric 128, 130 attached to each of the motor shafts 133, 135. According to certain embodiments, the motor shaft 133, 135 may extend from either end of the motor 132, 134, and an eccentric mass may be attached to each end of the motor shaft 133, 135.

As to the sensors 106, 108 included in the vibratory apparatus of FIG. 1, it has already been mentioned that the weight sensor 108 may be a load cell, such as manufactured by Hardy Process Solutions, Inc. of San Diego, Calif. The motion sensor 106 may include at least one optical sensor configured to determine a position of at least one object on the deck 102 at different points in time during the transporting interval, and to generate the signal representative of material flow rate based on the positions of the at least one object at the different points in time. Such an optical motion sensor system is the In-Sight 7600 vision system manufactured by Cognex Corp. of Natick, Mass. Alternatively, the motion sensor 106 may include a plurality of sensors disposed along the length of the trough 150, and the motion sensor may provide a signal based on the motion of the material between the plurality of sensors. Other electrical or electro-mechanical speed sensors may also be used instead of an optical-based sensor.

As mentioned above, the vibratory apparatus 100 may be included as part of a system 200, such as a system to charge a furnace 202. FIGS. 2 and 3 illustrate a part of such a system 200, while FIG. 4 describes the system 200 in further detail.

The system 200 may include a conveyor system 204 with a first end 206 and a second end 208 and including at least one conveyor. As illustrated in FIGS. 2 and 3, the conveyor system 204 includes at least three conveyors, one of which (the second or middle conveyor) is the vibratory apparatus 100 of FIG. 1. The conveyor system 204 may, and likely will, include additional conveyors upstream of the first (left) conveyor illustrated, to move material to the portion of the system illustrated in FIGS. 2 and 3.

The first and third conveyors 210, 212 of the part of the conveyor system 204 illustrated are substantially similar to the second conveyor 100 in structure. That is, conveyors 210, 212 include a deck 220, 222 having a longitudinal axis 224, 226 from a first end 228, 230 to a second, opposite end 232, 234, and an exciter assembly 236, 238 comprising at least one eccentric mass 240, 242, 244, 246 and at least one motor 248, 250, 253, 254 coupled to the at least eccentric mass 240, 242, 244, 246, the exciter assembly 236, 238 coupled to the deck 220, 222 and configured to move material along the deck 220, 222. As illustrated, all three conveyors use a two-mass system with two motors, the eccentric masses attached to the motor shafts. It will be recognized that it is not required that all three conveyors have the same or similar features, and thus the conveyors may vary from each other according to other embodiments.

The first conveyor 210 is disposed at a higher elevation than the second conveyor 100, such that the material that enters the first conveyor 210 is moved along the first conveyor 210 and exits the second end 232 into the first end 122 of the second conveyor 100. Similarly, the second conveyor 100 is disposed at a higher elevation than the third conveyor 212, such that the material that moves along the second conveyor 100 from the first end 122 to the second end 124 exists the second end 124 into the third conveyor 212. The material moving from the first end 230 to the second end 234 of the third conveyor 212 exits the third conveyor 212 into the furnace 202.

In operation, both the first and second conveyors 210, 100 of the illustrated embodiment may vary operation between a run phase or interval and a dwell phase or interval. During the run phase, material is moved or conveyed between the first and second ends of the conveyor. During the dwell phase, material is not moved or conveyed between the first and second ends of the conveyor. By contrast, the third conveyor 212 of the illustrated embodiment may be in continuous operation, moving material from the first end of the conveyor to the second end.

As mentioned above, the second conveyor 100 includes at least one motion sensor 106 associated with the deck, the at least one motion sensor 106 configured to generate a signal based on motion of material along the deck 102 between the first end 122 and the second end 124, at least one weight sensor 108 coupled to the deck 102, the at least one weight sensor 108 configured to generate a signal based on weight of material on the deck 102, and a control system 110 coupled to the at least one motor 132, 134, the at least one motion sensor 106, and the at least one weight sensor 108. See FIG. 1. As also mentioned, the control system 110 is configured to pause the rate of travel of the material across the deck 102 for a weighing interval, to receive the signal from the at least one weight sensor 108 representative of a material weight on the deck during the weighing interval, to resume the rate of travel of the material across the deck 102 for a transporting interval, to receive a signal from the at least one motion sensor 106 representative of a material flow rate during the transporting interval, to determine a material mass flow rate based on the signal from the at least one weight sensor 108, the signal from at least one motion sensor 106, the weighing interval and the transporting interval, and to vary the operation of the motor 132, 134 according to the material mass flow rate. The additional specifics of the operation of the vibratory apparatus 100 above apply with equal force to the vibratory apparatus 100 as incorporated as the second conveyor of the system 200 of FIGS. 2 and 3.

The conveyor system 204 moves material into the furnace 202 of the system 200 to charge the furnace 202. According to the illustrated embodiment, the furnace 202 may be an electric arc furnace, which furnace 202 may include a shell 270 and a roof 272, which roof 272 may be displaceable (e.g., translatable) relative to the shell 270. The furnace 202 may have an opening 274 to receive the end 234 of the conveyor 212, which conveyor 212 may be mounted on a moveable frame 276 to permit the conveyor 212 to be moved towards and away from the furnace 202. The furnace 202 may include one or more openings 278 to permit one or more electrodes 280 to be disposed through the roof 272 of the furnace 202.

In operation, material from the first conveyor 210 is moved to the second conveyor 100 and material from the second conveyor 100 is moved to the third conveyor in a series of alternating run and dwell phases. The material from the third conveyor 100, however, is introduced into the furnace 202 at a continuous rate. To achieve a desired mass flow rate into the furnace 202, an operator can enter a target mass flow rate for the conveyor 100 via the input 138 into the control system 110 of the conveyor 100. As explained above, the control system 110 uses the signals received from the sensors 106, 108 to determine a mass flow rate for the conveyor 100, and then varies the operation of the exciter assembly 104, and in particular motors 132, 134, so that a target mass flow rate is achieved. In this fashion, the control system 110 can be used to automatically maintain a desire mass flow rate into the furnace 202 while the material entering the conveyor system 204, and in particular the conveyor 100, changes over time.

The ability of the conveyor 100 to vary its operation to maintain a desired mass flow rate is particularly advantageous where the nature of the material being used to charge the furnace 202 varies over time. The recycling of steel scrap through the use of an electric arc furnace can require significantly less energy and at significantly reduced emission than the production of steel from iron ore, whether that new steel is produced from iron ore via the traditional blast furnace route or the newer direct reduction route. Of course, the nature of the scrap can vary depending on its source. The use of a system incorporating a conveyor having mass flow control, such as the conveyor 100, permits a wider variation in the scrap to be utilized, thereby permitting a varied of sources to be used by a single steel recycling facility.

The system 200, a portion of which is illustrated in FIGS. 2 and 3, may itself be a sub-system of an extended or expanded system 300 to recycle scrap material into billets of cast metal, as is illustrated schematically in FIG. 4. According to this expanded system 300, scrap material, for example scrap steel, is converted into cast metal billets, for example steel billets, through the use of an electric arc furnace, such as the furnace 202. This system 300 may be enhanced through the use of a conveyor system 204 incorporating a vibratory apparatus 100 with mass flow control, such as is illustrated in FIG. 1.

In addition to the system (or sub-system) 200, the system 300 includes a source 302 of scrap material. For example, the source 302 may be in the form of one or more railroad cars loaded with scrap material, such as scrap steel. Alternatively, the source 302 of scrap material may be in the form of a pile of scrap metal that is generated as metal is scrapped from an existing use. The scrap material at the source 302 may be combined with other charge materials, which may be transported to the source 302 via additional conveyors. The source 302 may also include equipment to separate contaminants, such as dirt, from the scrap material.

The system 300 also includes a transfer system 304 that moves the scrap material 302 from the source to the conveyor system 204 illustrated in part in FIGS. 2 and 3. For example, the transfer system 304 may include handling equipment in the form of one or more overhead magnets that are used to lift the scrap material, for example scrap steel, from the source (e.g., railroad cars) 302. Alternative, cranes or loaders may be used instead of the one or more overhead magnets. The transfer system 304 also may include one or more conveyors, similar to the vibratory conveyors illustrated in FIGS. 2 and 3, to move the scrap material lifted from the source 302 by the magnets, cranes or loaders to the conveyor system 204. Because the conveyor system 204 may include conveyors other than those illustrated in FIGS. 2 and 3, part of the transfer system 304 may overlap with the conveyor system 204.

The system 300 also includes one or more casting stations 306 associated with the furnace 202. The stations 306 may include cars that move along tracks (similar to railroad cars) that carry molten metal from the furnace 202 to a caster that is configured to mold the liquid metal into billets. The stations 306 may also include equipment for removing the formed billets from the molds, and for transporting the billets from the casting station 306. The casting station 306 may also be in the form of a continuous caster for continuous casting that receives molten metal directly from the furnace 202.

According to the illustrated embodiment, the system 300 optionally may include a preheater 308 that is used to preheat the scrap before the scrap is introduced into the furnace. The preheater 308 may be integrated with or overlap with the conveyor system 204. The preheater 308 may receive heated gases from the furnace 202 and transport the heated gases to the conveyor system 204 to heat the scrap metal moving along the conveyor system 204. After heat exchange with the scrap metal, the heated gases may be forwarded to an exhaust treatment system 310 to limit the exhaust of unwanted emissions.

The preheater 308 may include one or more insulated hoods, for example, a single hood including a plurality of hood sections, each hood section disposed over one of the conveyors 100, 210, 212 of the conveyor system 204. The hood may be separate from the conveyors 100, 210, 212, mounted stationary to the ground (or supporting structure), such that each of the conveyors 100, 210, 212 operates independently of the hood; alternatively, the hoods may be secured to the conveyors 100, 210, 212, but mounted relative to the ground (or supporting structure) such that the hoods may move with the conveyors 100, 210, 212. The hood may have a seal disposed between the sides of the hood and the sides of the conveyors 100, 210, 212 to limit the escape of gases from the conveyor system 204 and preheater 308.

The hood may include equipment, for example curtains depending from the hood in the direction of the conveyors 100, 210, 212, to change the direction of the heated gases within the hood. Such equipment may be adjustable so that a greater or lesser percentage of the gases are directed against the scrap material for heat exchange with the scrap material (and other charge materials that may have been combined with the scrap material).

According to one embodiment, the heated gases are directed from the conveyor 212 closest to the furnace 202 to the conveyor 100, from the conveyor 100 to the conveyor 210, and from the conveyor 210 to the exhaust treatment system 310. A gas seal may be used at the conveyor 210 to prevent gases from limiting the exit of gases except through the exhaust treatment system 310. For example, the gas seal may include one or more curtains, and one or more blowers to create a negative pressure in the seal. The seal may also include equipment to remove dust from the air moved by the one or more blowers before it is exhausted to the environment.

The exhaust treatment system 310 may include conventional equipment to remove unwanted emissions. The system 310 may also include equipment, for example cyclonic separators, for removing materials entrained with the heated gases. The system 310 may also include equipment for directing the flow of the gases through the system 310, such as dampers and fans.

In operation, the scrap material from the source 302 is transferred to the conveyor system 204 via the transfer system 304. While being transported along the conveyor system 204, the scrap material may be preheated as a consequence of the action of the preheater 308 associated with the conveyor system 204. As explained above, the preheater 308 may direct heated gases from the furnace onto the scrap material moving along the conveyor system 204 to heat the scrap material before the scrap material is introduced into the furnace 202. After the gases have undergone heat exchange with the scrap material, the gases may be directed (e.g., through the action of the gas seal and the structure of the preheater 308) into the exhaust treatment system 310, which limits the contaminants and unwanted emissions exiting the system 300.

The pre-heated scrap material is then charged into the furnace 202 by the conveyor system 204. Using the conveyor 100 with mass flow control, the amount of pre-heated scrap material entering the furnace 202 may be selected to achieve a desired mass flow into the furnace 202. Once the scrap material is heated into molten metal in the furnace 202, the molten metal may be directed to the casting station 306 to be molded into metal billets.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A vibratory apparatus comprising:
a deck having a longitudinal axis from a first end to a second, opposite end;
an exciter assembly comprising at least one eccentric mass and at least one motor coupled to the at least eccentric mass, the exciter assembly coupled to the deck and configured to move material along the deck;
at least one motion sensor associated with the deck, the at least one motion sensor configured to generate a signal based on motion of material along the deck between the first end and the second end;
at least one weight sensor coupled to the deck, the at least one weight sensor configured to generate a signal based on weight of material on the deck; and
a control system coupled to the at least one motor, the at least one motion sensor, and the at least one weight sensor, the control system configured:
to pause the rate of travel of the material across the deck for a weighing interval,
to receive the signal from the at least one weight sensor representative of a material weight on the deck during the weighing interval,
to resume the rate of travel of the material across the deck for a transporting interval,
to receive a signal from the at least one motion sensor representative of a material flow rate during the transporting interval,
to determine a material mass flow rate based on the signal from the at least one weight sensor, the signal from at least one motion sensor, the weighing interval and the transporting interval, and
to vary the operation of the at least one motor according to the material mass flow rate.

2. The vibratory apparatus according to claim 1, wherein the control system is configured:
to determine a material weight per unit length based on the signal from the at least one weight sensor,
to determine a material flow rate based on the signal from the at least one motion sensor,
to determine an intermediate material mass flow rate based on material weight per unit length and the material flow rate, and
to determine the material mass flow rate based on the intermediate material mass flow rate, a duration of the weighing interval, and a duration of the transporting interval.

3. The vibratory apparatus according to claim 2, wherein the system is configured to determine the material flow rate based on the product of the intermediate material mass flow rate and a percentage of the transporting interval taken relative to a total interval, which is the sum of the weighing interval and the transporting interval.

4. The vibratory apparatus according to claim 1, wherein the at least one motor comprises a motor shaft transverse the longitudinal axis of the deck, and the at least one eccentric is attached to the motor shaft.

5. The vibratory apparatus according to claim 4, wherein the control system is configured to compare the material mass flow rate to a target mass flow rate, and to vary the operation of at least one motor based on the material mass flow rate and the target mass flow rate.

6. The vibratory apparatus according to claim 5, further comprising an input coupled to the control system, the input configured to receive the target mass flow rate and to transmit the target mass flow rate to the control system.

7. The vibratory apparatus according to claim 5, wherein the control system comprises a variable frequency drive coupled to the at least one motor, and the control system is configured to control the variable frequency drive to change a revolutions per minute of the motor during the transporting interval.

8. The vibratory apparatus according to claim 1, wherein the at least one motor comprises two motors each with a motor shaft transverse the longitudinal axis of the deck, and the at least one eccentric comprises at least one eccentric attached to each of the motor shafts.

9. The vibratory apparatus according to claim 8, wherein the control system is configured to compare the material mass flow rate to a target mass flow rate, and to vary the operation of the two motors based on the material mass flow rate and the target mass flow rate.

10. The vibratory apparatus according to claim 9, further comprising an input coupled to the control system, the input configured to receive the target mass flow rate and to transmit the target mass flow rate to the control system.

11. The vibratory apparatus according to claim 9, wherein the control system comprises a variable frequency drive coupled to each motor, and the control system is configured to control each variable frequency drive to change a revolutions per minute of the motor during the transporting interval.

12. The vibratory apparatus according to claim 1, wherein the exciter assembly is coupled to the vibratory apparatus by a plurality of resilient members.

13. The vibratory apparatus according to claim 1, wherein the weight sensor is a load cell, and the deck is coupled to the load cell.

14. The vibratory apparatus according to claim 1, wherein the motion sensor is at least one optical sensor configured to determine a position of at least one object on the deck at different points in time during the transporting interval, and to generate the signal representative of material flow rate based on the positions of the at least one object at the different points in time.

15. A system to charge a furnace, the system comprising:
a conveyor system with a first inlet end and a second outlet end and including at least one conveyor, the at least one conveyor comprising a conveyor comprising:
a deck having a longitudinal axis from a first end to a second, opposite end;
an exciter assembly comprising at least one eccentric mass and at least one motor coupled to the at least eccentric mass, the exciter assembly coupled to the deck and configured to move material along the deck;
at least one motion sensor associated with the deck, the at least one motion sensor configured to generate a signal based on motion of material along the deck between the first end and the second end;
at least one weight sensor coupled to the deck, the at least one weight sensor configured to generate a signal based on weight of material on the deck; and
a control system coupled to the at least one motor, the at least one motion sensor, and the at least one weight sensor, the control system configured:
to pause the rate of travel of the material across the deck for a weighing interval,
to receive the signal from the at least one weight sensor representative of a material weight on the deck during the weighing interval,
to resume the rate of travel of the material across the deck for a transporting interval,
to receive a signal from the at least one motion sensor representative of a material flow rate during the transporting interval,
to determine a material mass flow rate based on the signal from the at least one weight sensor, the signal from at least one motion sensor, the weighing interval and the transporting interval, and
to vary the operation of the motor according to the material mass flow rate; and
a furnace disposed at the second end of the conveyor system.

16. The system according to claim 15, wherein the furnace is an electric arc furnace.

17. The system according to claim 15, wherein the control system is configured:
to determine a material weight per unit length based on the signal from the at least one weight sensor,
to determine a material flow rate based on the signal from the at least one motion sensor,
to determine an intermediate material mass flow rate based on material weight per unit length and the material flow rate, and
to determine the material mass flow rate based on the intermediate material mass flow rate, a duration of the weighing interval, and a duration of the transporting interval.

18. The system according to claim 17, wherein the system is configured to determine the material flow rate based on the product of the intermediate material mass flow rate and a percentage of the transporting interval taken relative to a total interval, which is the sum of the weighing interval and the transporting interval.
